(19) United States
(12) Patent Application Publication
(10) Pub. No.: US 2025/0022670 A1
(43) Pub. Date: Jan. 16, 2025

(54) MOTOR CONTROL CENTER (MCC) BUCKET INTERLOCK WITH STRUCTURE FOR SAFE OPERATION OF DISCONNECT FOR COMPACT DESIGN ROTARY SWITCHES

(71) Applicant: Eaton Intelligent Power Limited, Dublin (IE)

(72) Inventors: Shriram Ghorpade, Maharashtra (IN); Prasenjit Nath, Maharashtra (IN); Kristy Burney, Supply, NC (US); Deepak Shinde, Maharashtra (IN); John Bordewick, Fayetteville, NC (US); Vishal Gortyal, Maharashtra (IN)

(21) Appl. No.: 18/772,683

(22) Filed: Jul. 15, 2024

Related U.S. Application Data
(60) Provisional application No. 63/513,588, filed on Jul. 14, 2023.

(51) Int. Cl. H01H 9/28

(52) U.S. Cl. CPC H01H 9/28

(57) ABSTRACT

A bucket interlock mechanism is provided for use with a motor control center (MCC) receiving a bucket having a rotary switch. The bucket interlock mechanism physically restricts a disconnect “ON” condition when the bucket is not locked in the MCC.

### CLAIM OF PRIORITY

The present application claims the benefit of and priority to U.S. Provisional Application No. 63/513,588, filed on Jul. 14, 2023 entitled Motor Control Center (MCC) Bucket Interlock with Structure for Safe Operation of Disconnect for Compact Design Rotary Switches, the content of which is hereby incorporated herein by reference as if set forth in its entirety.

### FIELD

The present inventive concept relates generally to compact rotary switches and, more particularly, safety mechanisms for rotary switches used in combination with Motor Control Centers (MCCs).

### BACKGROUND

Power distribution is a vital aspect of everyday life. Industrial, manufacturing, and commercial sectors generally need an uninterrupted supply of power. Power distribution systems that are used for these applications are extraordinarily complex.

For such applications, power is often distributed through switchgear, switchboards, transformers, and panel boards. The power that is distributed in industrial, manufacturing, and other commercial plants are used for a variety of purposes such as heating, cooling, lighting, and the application of several electrical and motor-driven equipment.

When motor-driven equipment or machinery is used, motor control centers (MCCs) are generally in place to increase efficiency and safety. In other words, a motor control center is used to control the function and operation of the motors in the plant. The MCC structure houses the MCC buckets.

Motor Control Centers (MCC) can include cabinets or enclosures that hold multiple, typically modular, bucket assemblies of various sizes. See, e.g., U.S. Pat. No. 4,024,441, the contents of which are hereby incorporated by reference as if recited in full herein. Motor control centers are used, for example, in some commercial and industrial applications to distribute electrical power to a variety of loads, for example, without limitation, relatively high-power electrical motors, pumps, and other loads.

The bucket assemblies (also known as “buckets” or “units”) can include handles that are disposed on the front door. Some conventional MCC buckets are offered with up/down handle mechanisms. Example up/down handle mechanisms are illustrated in FIGS. 1A and 1B. In particular, an example up/down handle 190 is shown in FIG. 1A. Up/down handles 190 are shown installed on buckets 110 of an MCC 105 in FIG. 1B. The up/down handle mechanism has a lot of moving parts and may be very complicated.

In other conventional buckets, the handle can be a rotary handle configured to convert the rotary motion of the rotary handle to the linear or translational motion of a circuit breaker linear action lever. An example rotary handle is discussed, for example, U.S. Pat. Nos. 6,194,983 and 7,186,933, the contents of which are incorporated by reference as if recited in full herein. The handle is typically mounted parallel with the plane of the faceplate of the molded case circuit breaker but spaced outwardly from it by the depth of the handle mechanism. Usually, a series of linkages are utilized to interconnect the rotary motion of the rotary handle to the linear motion of the circuit breaker handle or lever.

Referring to FIG. 1B, a portion of a control center 105 is shown. The motor control center 105 includes a multi-compartment enclosure 112 for receiving a plurality of motor control units 110. Typically, each bucket 110 is a removable, pull-out unit that has a respective door (which may be under a front panel). The door is typically coupled to the housing 112 by hinges (not shown) to permit access to motor control components of the bucket 110 while it is installed in the enclosure 112. For example, the door may permit access to a circuit breaker assembly, a stab indicator, a shutter indicator, a line contact actuator and the like. Details with respect to MCCs and units therefore (referred to as “subunits”) are discussed, for example, in commonly assigned U.S. Patent Application Publication Nos. 2009/0086414; 2008/0258667; 2008/0023211; and 2008/0022673, the contents of which are hereby incorporated herein by reference.

The MCC is equipment that is a combination of one or more sections that have a common power bus. This common point consists of all the motor control systems and units. The MCC turns the motor on and off. Some MCCs use a motor starter that has a contactor and overload relay to do so. The contacts on the contactor are closed to start the motor and are opened to close the motor.

As discussed above, conventional MCC buckets that are offered with an up/down handle mechanism 190 increase bucket height. Because of which, same rating buckets cannot be offered in smaller/compact units. Furthermore, conventional MCC buckets generally need a separate fixture to adjust the moving parts (links) in the up/down handle mechanism, which may increase assembly time. Accordingly, improved systems are desired.

### SUMMARY

Some embodiments of the present inventive concept provide a bucket interlock mechanism for use with a motor control center (MCC) receiving a bucket having a rotary switch. The bucket interlock mechanism physically restricts a disconnect “ON” condition when the bucket is not locked in the MCC.

In further embodiments, the bucket interlock mechanism may include a main gear having a slot therein; a latch; an L-bracket; a bucket interlock plate; and an E-frame base plate. A portion of the bucket interlock plate slides into the slot of the main gear responsive to movement of the rotary switch during an “OFF” condition. Further, a portion of the bucket interlock plate is removed from the slot of the main gear responsive to a different movement of the rotary switch during an “ON” condition.

In still further embodiments, when the portion of the interlock plate is engaged with the slot of the main gear during an “OFF” condition, the disconnect cannot be turned on due to the engagement of the main gear and the interlock plate.

In some embodiments, the rotary switch may be turned counterclockwise to place the bucket in the “OFF” condition.

In still further embodiments, when the portion of the bucket interlock plate is removed from the slot of the main gear during an “ON” condition, the bucket interlock plate is engaged with a side sheet of the bucket and the main gear is free of the portion of the bucket-interlock plate from the slot.

In some embodiments, the rotary switch may be rotated clockwise to place the mechanism in the ON condition.

In further embodiments, the latch may be a spring-loaded latch.

In still further embodiments, the bucket interlock mechanism may be operable in a closed-door state to provide a safe operating condition for an operator.

In some embodiments, the latch may secure the bucket with an MCC structure frame to provide an additional level of safety.

In further embodiments, the bucket may be positioned in a multi-compartment enclosure of the MCC.

In still further embodiments, buckets including the bucket interlock may occupy less space in the multi-compartment enclosure and more buckets may be provided in a single enclosure.

In some embodiments, the bucket interlock mechanism may be installed on an interior side of a door of the bucket.

MCC embodiments are also provided herein.

### BRIEF DESCRIPTION OF THE DRAWINGS

FIGS. 1A and 1B are diagrams illustrating an up/down mechanism and an MCC utilizing the same, respectively.

FIG. 2 is a diagram illustrating a rotary handle mechanism in accordance with some embodiments of the present inventive concept.

FIG. 3 is a diagram illustrating a rotary handle mechanism installed on a bucket of an MCC in accordance with some embodiments of the present inventive concept.

FIGS. 4A and 4B are diagrams illustrating a rotary handle mechanism bucket unit interlock with disconnect and MCC structure in accordance with some embodiments of the present inventive concept.

FIGS. 5A and 5B are diagrams illustrating a bucket interlock with disconnect structure in accordance with some embodiments of the present inventive concept.

FIG. 6 is a diagram illustrating a rotary mechanism on a bucket door in accordance with some embodiments of the present inventive concept.

FIG. 7 is an exploded view of the bucket in accordance with some embodiments of the present inventive concept.

FIG. 8 is a diagram illustrating an example spring loaded latch in accordance with some embodiments of the present inventive concept.

FIGS. 9A and 9B are side by side comparisons of an up/down mechanism (9A) on a bucket and a rotary handle mechanism (9B) with a mechanical feeder.

FIGS. 10A and 10B are side by side comparisons of an up/down mechanism (10A) on a bucket and a rotary handle mechanism (10B) with a mechanical starter.

FIGS. 11A and 11B are diagrams illustrating various views of an example multi-compartment housing that receives the buckets in accordance with embodiments discussed herein.

### DETAILED DESCRIPTION OF EMBODIMENTS

The inventive concept now will be described more fully hereinafter with reference to the accompanying drawings, in which illustrative embodiments of the inventive concept are shown. This inventive concept may, however, be embodied in many different forms and should not be construed as limited to the embodiments set forth herein; rather, these embodiments are provided so that this disclosure will be thorough and complete, and will fully convey the scope of the inventive concept to those skilled in the art. Like numbers refer to like elements throughout. As used herein, the term “and/or” includes any and all combinations of one or more of the associated listed items. Similarly, as used herein, the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Reference will now be made in detail in various and alternative example embodiments and to the accompanying figures. Each example embodiment is provided by way of explanation, and not as a limitation. It will be apparent to those skilled in the art that modifications and variations can be made without departing from the scope or spirit of the disclosure and claims. For instance, features illustrated or described as part of one embodiment may be used in connection with another embodiment to yield a still further embodiment. Thus, it is intended that the present disclosure includes modifications and variations that come within the scope of the appended claims and their equivalents.

In the present disclosure, the terms “bucket” or “unit” are used interchangeably and are intended to mean a motor control center unit that may be configured to be a removable modular unit capable of being installed behind individual or combined sealed doors on the motor control center enclosure. The unit may contain various motor control and motor protection components such as motor controllers, starters, contactor assemblies, overload relays, circuit breakers, motor circuit protectors, various disconnects, and similar devices for electric motors. The unit is configured to connect to a common power bus of the motor control center and conduct supply power to the line side of the motor control devices for operation of motors or feeder circuits.

As discussed herein, units may be configured as “starter units” for supplying power controlling electrical motors and pumps or as general “feeder units” for supplying feeder circuits. The terms “bucket assembly”, bucket” and “unit” are used interchangeably and refer to a structure (typically having sides of a protective metal shell) that contains either a switch with a fuse or a circuit breaker for turning power ON and OFF to a motor, or feeder circuit, typically for controlling power to motor starters. As noted above, the bucket or unit can be a feeder unit or a starter unit. The bucket can include other components such as a power transformer, a motor starter to control a single motor and PLCs (programmable logic controllers), drives and the like. The bucket can be configured as a modular device to allow the internal components to be assembled as a unit that can be easily installed into a Motor Control Center (MCC) compartment. As is well known, the bucket can have a bus grid with “power stabs” in the back that connect to bus bars that carry power (current) to the compartments of a vertical section in an MCC cabinet. The bus bars are connected to larger horizontal bus bars that bring power to the vertical sections. The horizontal bus bars are usually at the top, but some MCC designs may have them in the center or bottom.

A “feeder unit” refers to a motor control center unit for supplying feeder circuits. A feeder unit may have one or more feeders or power supply lines to supply feeder circuits or devices. A feeder unit (also called a “feeder”) can have a “line side”, which refers to the side of the feeder configured to be directly or indirectly connected to the common power bus of the motor control center. A feeder can also have a “load side”, which refers to the side of the feeder configured to be connected to and deliver current to a feeder circuit. A feeder may comprise a circuit breaker, a fuse and disconnect switch, or another configuration. The terms “feeder circuit” and “feeder device” are used interchangeably and are intended to mean circuits or devices connected to feeder units or “feeders”.

A “circuit breaker,” “breaker,” “molded case circuit breaker,” or “MCCB” is a device designed to open and close a circuit, typically allowing both manual open and close operation and automatic circuit interruption, the latter to open a circuit under certain conditions, e.g., an over-current. The circuit breaker can be for a motor starter unit or feeder unit, for example.

The terms “motor”, “load”, and “load device” are used interchangeably and are intended to mean devices bearing electrical load that are connected to and controlled by the motor control center. Load devices are typically motors but may also be pumps or other machinery that may comprise motors or pumps. Load devices may be connected to starter units.

The terms “operating mechanism” and “operator mechanism” are used interchangeably and refer to an assembly for opening and closing separable main contacts in a circuit breaker or for turning power ON and OFF using a switch associated with a fuse as a disconnect.

MCCs usually have a wire way for wires from respective units to the motors and other loads and control wires. U.S. Patent Application Publication 2013/0077210 describes an MCC with both right and left side wireways, the contents of which are hereby incorporated by reference as if recited in full herein. The wireways are typically provided as an enclosed space in an MCC cabinet proximate but outside stacked units. MCCs can be configured in many ways. Each compartment can have a different height to accept different frame sizes of respective bucket assemblies or units, typically in about 6-inch increments. The vertical bus can be omitted or not run through the full height of the section to accommodate deeper buckets for larger items like variable frequency drives. The MCC can be a modular cabinet system for powering and controlling motors or feeder circuits. Several may be powered from the main switchgear which, in turn, gets its power from a transformer attached to the incoming line from the power company. A typical MCC cabinet is an enclosure with a number of small doors arranged in rows and columns along the front. The back and sides are typically flat and mostly featureless. The buckets can be provided in varying sizes. For starter units, the size can be based on the size of the motor they are controlling. The bucket assembly can be configured to be relatively easily removable for repair, service or replacement. MCCs can have regular starters, reversing starters, soft start, and variable frequency drives. MCCs can be configured so that sections can be added for expansion if needed. The buckets or units of a motor control center can have the same or different configurations.

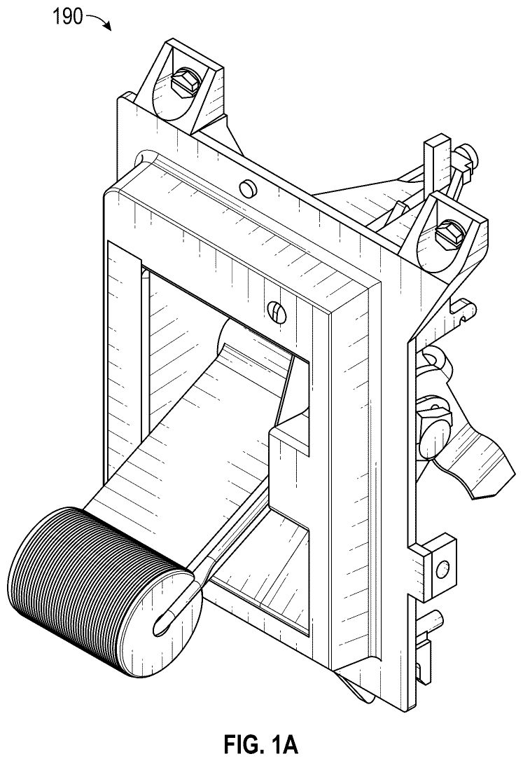

As discussed above, conventional MCC buckets are offered with an up/down handle mechanism that increases bucket height as illustrated in FIGS. 1A and 1B. Because of which, same rating buckets cannot be offered in smaller/compact units. Furthermore, conventional MCC buckets generally need a separate fixture to adjust the moving parts (links) in the up/down handle mechanism, which may increase assembly time.

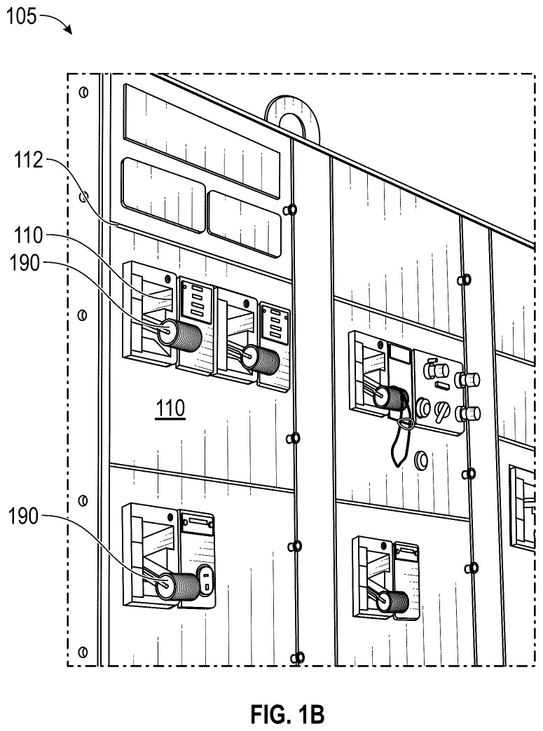

Accordingly, some embodiments of the present inventive concept provide a bucket interlock mechanism with a rotary switch 120 (FIG. 2) to increase the likelihood of safe operation of disconnect by restricting a Disconnect “ON” condition when the bucket in not locked in the structure (e.g. MCC) and vice versa. Embodiments of the present inventive concept may also be useful in avoiding arc flash events if, for example, an operator tries to pull the bucket from the MCC when the disconnect is in an “ON” condition as will be discussed further herein.

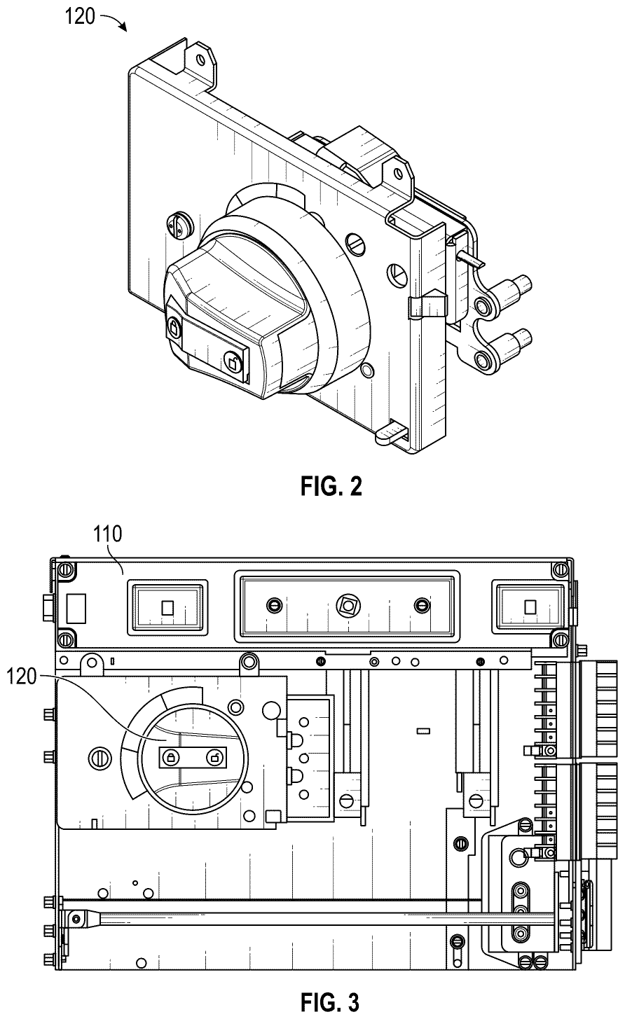

Only the interlocking mechanism will be discussed in detail herein. However, it will be understood that the interlocking mechanism is included on a bucket of an MCC as discussed above with respect to FIG. 1B. A rotary switch installed on a bucket 110 is illustrated in FIG. 3. It will be understood that although embodiments of the present inventive concept are discussed herein as being used in combination with MCC buckets, embodiments are not limited thereto. Features discussed in accordance with embodiments discussed herein may be used in any environment where they could be useful without departing from the scope of the present inventive concept.

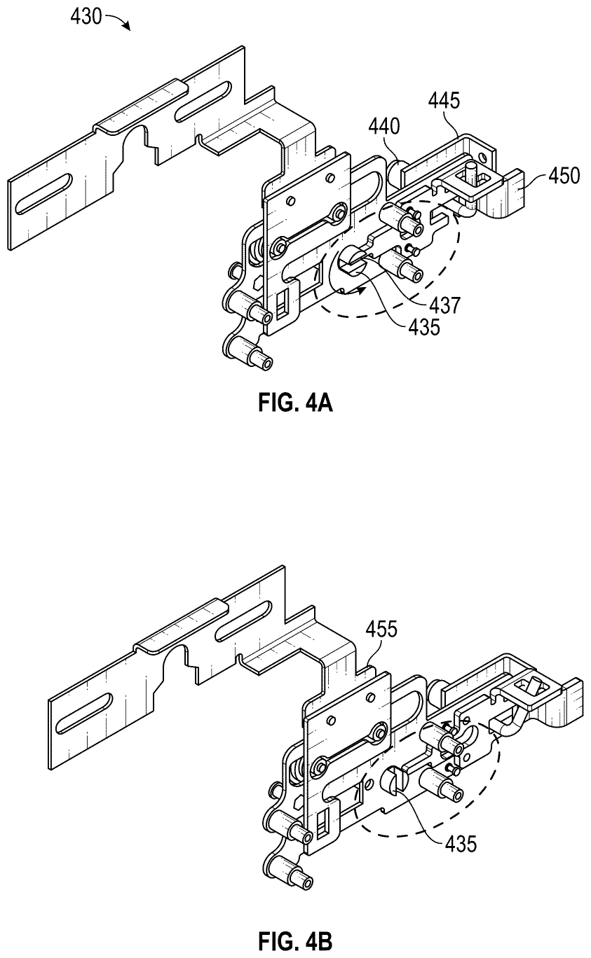

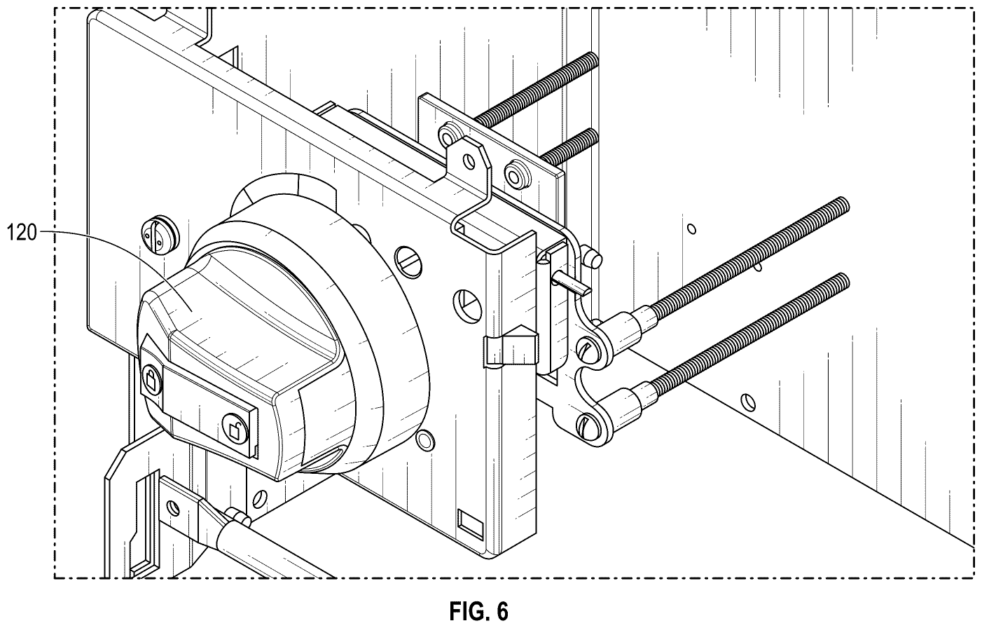

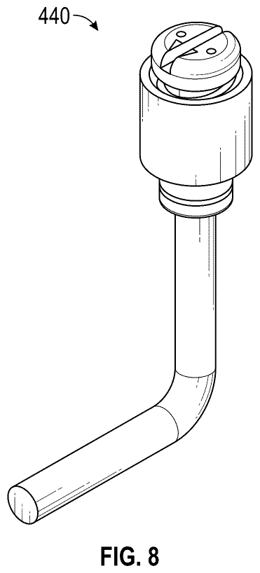

Referring to FIGS. 4A and 4B, the interlocking mechanism in accordance with some embodiments of the present inventive concept will be discussed. The mechanism shown in FIGS. 4A and 4B may be installed, for example, on the back of the door of the bucket as illustrated, for example, in FIG. 6 discussed below. The locking mechanism 430 includes a main gear 435 having a slot therein 437, a spring-loaded latch 440 (FIG. 8), an L-bracket 445, a bucket interlock plate 450 and an E-frame base plate 455. It will be understood that there are other elements that may be discussed, but in the interest of brevity only those elements related to the interlocking mechanism will be discussed herein. Furthermore, the interlocking mechanism of FIGS. 4A and 4B are provided for example only and embodiments are not limited to the specifics therein. For example, although the latch 440 is described as spring loaded latch, embodiments may use a different structure for this function without departing from the scope of the present inventive concept.

As illustrated in FIG. 4A, during operation, i.e., movement of the rotary switch 120, a portion of the bucket interlock plate 450 slides into the slot 437 of the main gear 435 (engages with the main gear) during an “OFF” condition. Thus, when the portion of the interlock plate 450 is engaged with the slot 437 of the main gear 435, i.e. in the “OFF” position, an operator/user cannot turn on the disconnect because the engagement does not allow any movement. In some embodiments, the rotary mechanism 120 is turned counterclockwise to place the apparatus in an “OFF” state, however, embodiments are not limited thereto. For example, in some embodiments, the rotary switch may be turned clockwise to place the apparatus in the “OFF” state without departing from the scope of the present inventive concept.

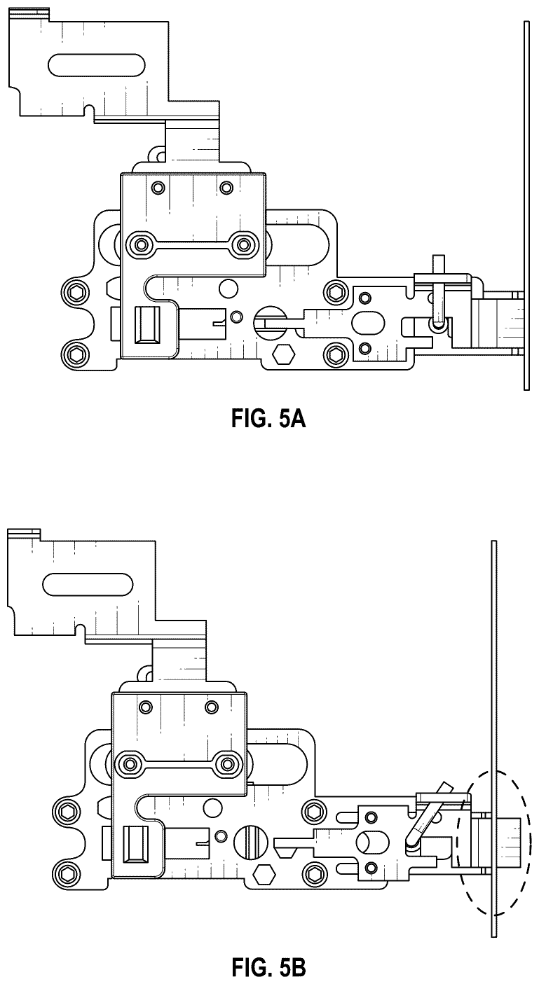

Similarly, as illustrated in FIG. 4B, during operation, a portion of the bucket interlock plate 450 is removed from the slot 437 of the main gear during an “ON” condition. Thus, the bucket interlock plate 450 is engaged with the structure (shown in FIG. 5B) when the main gear 435 is free of the portion of the bucket-interlock plate from the slot. The rotary mechanism may be rotated clockwise to turn the apparatus ON, however, as discussed above, embodiments of the present inventive concept are not limited to this configuration.

In further detail, the gear part has been extended with additional slot 437 (Cutout) which restricts the disconnects (ON/OFF) operation with the help of bucket interlock plate 450 by engaging with structure side sheet. The bucket interlock plate 450 is designed in such way closed-door operated through unit latch assembly (Spring loaded), which is mounted on a door of the bucket (shown in FIG. 6) and can be operated in a closed door condition, which is a safe operating condition for an operator in case of, for example, an arc flash event.

FIGS. 5A and 5B illustrate the positioning of the main gear and the bucket interlock plate 450 during the OFF and ON, respectively, conditions. As illustrated, the latch secures the bucket with MCC structure frame (shown in FIG. 5B) providing an additional level of safety.

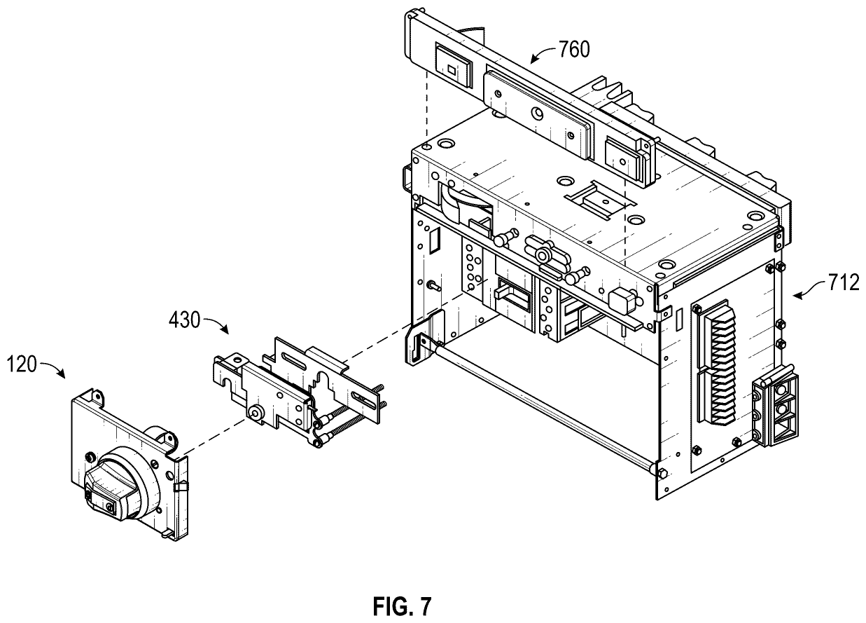

Referring now to FIG. 7, an exploded view of the interlocking mechanism and the bucket will be discussed. As illustrated, the rotary switch/mechanism 120 is positioned on the door of the bucket with the interlocking mechanism 430 installed on an opposite side (internal) thereof. The assembled bucket may then be positioned in the multi-compartment enclosure 712 of the MCC. As further illustrated, in some embodiments, a shutter cover 760 may be provided.

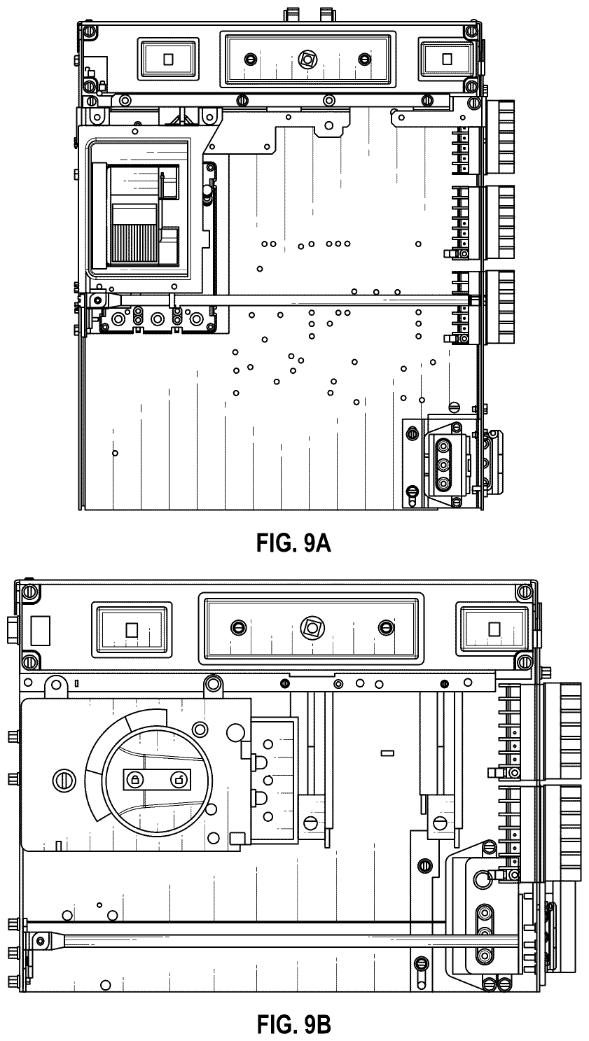

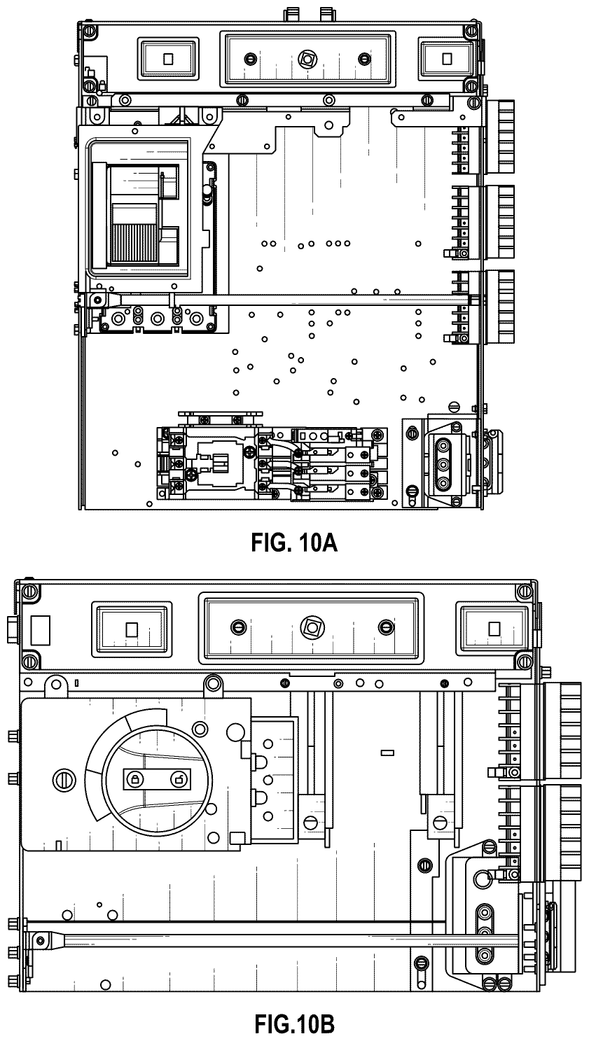

FIGS. 9A and 9B are side by side comparisons of an up/down mechanism (9A) on a bucket and a rotary handle mechanism (9B) with a mechanical feeder. Similarly, FIGS. 10A and 10B are side by side comparisons of an up/down mechanism (10A) on a bucket and a rotary handle mechanism (10B) with a mechanical starter. As illustrated, the rotary embodiments take up less space and, therefore, more buckets may be provided in one housing.

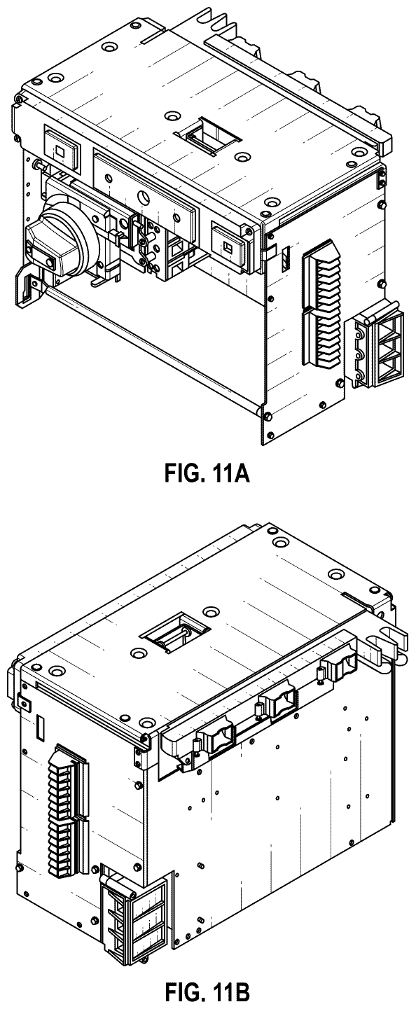

Finally, FIGS. 11A and 11B are diagrams illustrating various views of an example multi-compartment housing that receives the buckets in accordance with embodiments discussed herein. These figures are provided as examples only and, therefore, embodiments are not limited thereto.

As briefly discussed above, some embodiments of the present inventive concept provide a bucket interlock plate that engages with a gear during an “OFF” condition and as a result the operator cannot turn “ON” the disconnect which indicates the bucket is not fixed in the structure. Similarly, when unit interlock plate is engaged with structure, the operator cannot remove the bucket from the structure until the disconnect is in the “OFF” condition.

Embodiments of the present inventive concept may provide additional safety to the operator, for example, an arc flash event; a more compact product with arc flash protection feature (FlashGard); a more compact product with FVNR starters; a reduction in bucket size from 3× (18″) to 2× (12″), saving valuable 1× (6″) space in the MCC structure.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

What is claimed is:

1. A bucket interlock mechanism for use with a motor control center (MCC) receiving a bucket having a rotary switch, the bucket interlock mechanism physically restricting a disconnect “ON” condition when the bucket is not locked in the MCC.

2. The bucket interlock mechanism of claim 1 comprising:
a main gear having a slot therein;
a latch;
an L-bracket;
a bucket interlock plate; and
an E-frame base plate,
wherein a portion of the bucket interlock plate slides into the slot of the main gear responsive to movement of the rotary switch during an “OFF” condition; and
wherein a portion of the bucket interlock plate is removed from the slot of the main gear responsive to a different movement of the rotary switch during an “ON” condition.

3. The bucket interlock mechanism of claim 2, wherein when the portion of the interlock plate is engaged with the slot of the main gear during an “OFF” condition, the disconnect cannot be turned on due to the engagement of the main gear and the interlock plate.

4. The bucket interlock mechanism of claim 3, wherein the rotary switch is turned counterclockwise to place the bucket in the “OFF” condition.

5. The bucket mechanism of claim 2, wherein when the portion of the bucket interlock plate is removed from the slot of the main gear during an “ON” condition, the bucket interlock plate is engaged with a side sheet of the bucket and the main gear is free of the portion of the bucket-interlock plate from the slot.

6. The bucket interlock mechanism of claim 5, wherein the rotary switch is rotated clockwise to place the mechanism in the ON condition.

7. The bucket interlock mechanism of claim 2, wherein the latch comprises a spring-loaded latch.

8. The bucket interlock mechanism of claim 1, wherein the bucket interlock mechanism is operable in a closed-door state to provide a safe operating condition for an operator.

9. The bucket interlock mechanism of claim 2, wherein the latch secures the bucket with an MCC structure frame to provide an additional level of safety.

10. The bucket interlock mechanism of claim 1, wherein the bucket is positioned in a multi-compartment enclosure of the MCC.

11. The bucket interlock mechanism of claim 10, wherein buckets including the bucket interlock mechanism occupy less space in the multi-compartment enclosure and more buckets may be provided in a single enclosure.

12. The bucket interlock mechanism of claim 1, wherein the bucket interlock mechanism is installed on an interior side of a door of the bucket.

13. A motor control center (MCC) that receives one or more buckets, each of the one or more buckets having a rotary switch and a bucket interlock mechanism, wherein the bucket interlock mechanism physically restricts a disconnect “ON” condition when the bucket is not locked in the MCC.

14. The MCC of claim 13, wherein the bucket interlock mechanism further comprises:
a main gear having a slot therein;
a latch;
an L-bracket;
a bucket interlock plate; and
an E-frame base plate,
wherein a portion of the bucket interlock plate slides into the slot of the main gear responsive to movement of the rotary switch during an “OFF” condition; and
wherein a portion of the bucket interlock plate is removed from the slot of the main gear responsive to a different movement of the rotary switch during an “ON” condition.

15. The MCC of claim 14, wherein when the portion of the interlock plate is engaged with the slot of the main gear during an “OFF” condition, the disconnect cannot be turned on due to the engagement of the main gear and the interlock plate.

16. The MCC of claim 14, wherein when the portion of the bucket interlock plate is removed from the slot of the main gear during an “ON” condition, the bucket interlock plate is engaged with a side sheet of the bucket and the main gear is free of the portion of the bucket-interlock plate from the slot.

17. The MCC of claim 14, wherein the latch comprises a spring-loaded latch.

18. The MCC of claim 13, wherein the bucket interlock mechanism is operable in a closed-door state to provide a safe operating condition for an operator.

19. The MCC of claim 14, wherein the latch secures the bucket with an MCC structure frame to provide an additional level of safety.

20. The MCC of claim 13, wherein the bucket is positioned in a multi-compartment enclosure of the MCC.
